(19) United States
(12) Patent Application Publication
(10) Pub. No.: US 2025/0041676 A1
(43) Pub. Date: Feb. 6, 2025

(54) Grommet

(71) Applicant: MIZUNO CORPORATION, Osaka-shi, Osaka (JP)

(72) Inventors: Yohei YAMASHITA, Osaka-shi, Osaka (JP); Hiroshi NAGAO, Osaka-shi, Osaka (JP); Daisuke YASUTOMI, Osaka-shi, Osaka (JP); Kan SAITO, Osaka-shi, Osaka (JP)

(21) Appl. No.: 18/718,095

(22) PCT Filed: Dec. 1, 2022
(86) PCT No.: PCT/JP2022/044365

§ 371 Date: Jun. 10, 2024

(30) Foreign Application Priority Data
Dec. 13, 2021 (JP) 2021-201893

(51) Int. Cl. A63B 49/022

(52) U.S. Cl. CPC A63B 49/022

(57) ABSTRACT

A grommet (20) includes a tubular portion (21). The tubular portion extends along a first direction (DR1), and has a tip end (21a) and a base end (21b) located opposite to the tip end in the first direction. The tubular portion is provided with a through hole (21c) extending in the first direction and opening at the tip end and the base end of the tubular portion. When the tubular portion is viewed from the tip end along the first direction, a first opening edge (21d) has a first portion (21da), the first opening edge being an opening edge of the through hole at the tip end of the tubular portion. The first portion has a first end and a second end, the first end being an intersection point of a first line (L1) and the first opening edge, the first line passing through a center (C) of the through hole and along a second direction (DR2) orthogonal to the first direction, the second end being an intersection point of a second line (L2) and the first opening edge, the second line passing through the center of the through hole and along a third direction (DR3) orthogonal to the first direction and the second direction.

### TECHNICAL FIELD

The present invention relates to a grommet.

### BACKGROUND ART

Japanese Patent No. 5992471 (PTL 1) describes a grommet. The grommet described in PTL 1 includes a tubular portion. The tubular portion extends along a first direction. The tubular portion has a tip end in the first direction. The tubular portion is provided with a communication hole passing therethrough along the first direction. An opening edge of the communication hole at the tip end has an elliptical shape, in which the major axis is oriented along a second direction when viewed from the tip end along the first direction. The first direction is along a direction of main strings. The second direction is orthogonal to the first direction, and is a direction in which the plurality of main strings are arranged.

### CITATION LIST

### Patent Literature

PTL 1: Japanese Patent No. 5992471

### SUMMARY OF INVENTION

### Technical Problem

When hitting a spin shot by a racket, a direction in which each main string is going to move forms an angle of approximately 600 with respect to the second direction. In the grommet described in PTL 1, therefore, the main string initially comes into contact with the opening edge of the communication hole at the tip end, resulting in insufficient movement of the main string in the second direction. Accordingly, the grommet described in PTL 1 has room for improvement in the amount of spin of a hit ball.

The present invention has been made in view of the problem with conventional techniques as described above. More specifically, the present invention provides a grommet that can improve the amount of spin of a hit ball.

### Solution to Problem

A grommet according to an aspect of the present invention includes a tubular portion. The tubular portion extends along a first direction, and has a tip end and a base end located opposite to the tip end in the first direction. The tubular portion is provided with a through hole extending in the first direction and opening at the tip end and the base end of the tubular portion. When the tubular portion is viewed from the tip end along the first direction, a first opening edge has a first portion, the first opening edge being an opening edge of the through hole at the tip end of the tubular portion. The first portion has a first end and a second end, the first end being an intersection point of a first line and the first opening edge, the first line passing through a center of the through hole and along a second direction orthogonal to the first direction, the second end being an intersection point of a second line and the first opening edge, the second line passing through the center of the through hole and along a third direction orthogonal to the first direction and the second direction. There are a first position and a second position on the first portion, the second position being further away from the first end than the first position in the third direction. When the tubular portion is viewed from the tip end along the first direction, a slope of a tangent of the first portion increases from the first end toward the first position, and decreases from the first position toward the second position.

In the grommet, a distance between the first portion and the center of the through hole may be at its maximum at the second position. When the tubular portion is viewed from the tip end along the first direction, an angle formed between a third line passing through the center of the through hole and the second position and the second line may be greater than 0° and smaller than or equal to 62°.

In the grommet, when the tubular portion is viewed from the tip end along the first direction, the angle formed between the third line and the second line may be greater than or equal to 7° and smaller than or equal to 56°.

In the grommet, when the tubular portion is viewed from the tip end along the first direction, the distance between the first portion and the center of the through hole may decrease from the second position toward the second end.

In the grommet, when the tubular portion is viewed from the tip end along the first direction, the first opening edge may further have a second portion, a third portion, and a fourth portion. The second portion may be line-symmetric with the first portion with respect to the first line. The third portion may be line-symmetric with the first portion with respect to the second line. The fourth portion may be point-symmetric with the first portion with respect to the center.

In the grommet, a maximum value of an opening diameter of a second opening edge may be smaller than or equal to a minimum value of an opening diameter of the first opening edge, the second opening edge being an opening edge of the through hole at the base end of the tubular portion.

A grommet according to another aspect of the present invention includes a tubular portion. The tubular portion extends along a first direction, and has a tip end and a base end located opposite to the tip end in the first direction. The tubular portion is provided with a through hole extending in the first direction and opening at the tip end and the base end. When the tubular portion is viewed from the tip end along the first direction, a first opening edge is X-shaped, the first opening edge being an opening edge of the through hole at the tip end of the tubular portion.

### Advantageous Effects of Invention

According to the grommet of the present invention, the amount of spin of a hit ball can be improved.

### BRIEF DESCRIPTION OF DRAWINGS

FIG. 1 is an exploded plan view of a racket 100.

FIG. 2 is a plan view of racket 100.

FIG. 3 is an end view of a tubular portion 21A.

FIG. 4 is a cross-sectional view along a line IV-IV in FIG. 3.

FIG. 5 is an end view of a tubular portion 21B.

FIG. 6 is a cross-sectional view along a line VI-VI in FIG. 5.

FIG. 7 is a schematic diagram illustrating movement of a main string 30 in a racket 200.

FIG. 8 is a schematic diagram illustrating movement of main string 30 in racket 100.

FIG. 9 is a graph showing results of a repulsion test using racket 100.

FIG. 10 is an end view of tubular portion 21A in racket 100 according to a modification.

FIG. 11 is an end view of tubular portion 21A in a racket 100A.

FIG. 12 is a schematic diagram illustrating movement of main string 30 in racket 100A.

FIG. 13 is an end view of tubular portion 21A in racket 100A according to a modification.

### DESCRIPTION OF EMBODIMENTS

Embodiments of the present invention will be described in detail with reference to the drawings. In the following drawings, the same or corresponding parts are denoted by the same reference characters and the same description will not be repeated.

### First Embodiment

A racket according to a first embodiment is described. The racket according to the first embodiment is referred to as a racket 100.

### <Schematic Configuration of Racket 100>

A schematic configuration of racket 100 is described below.

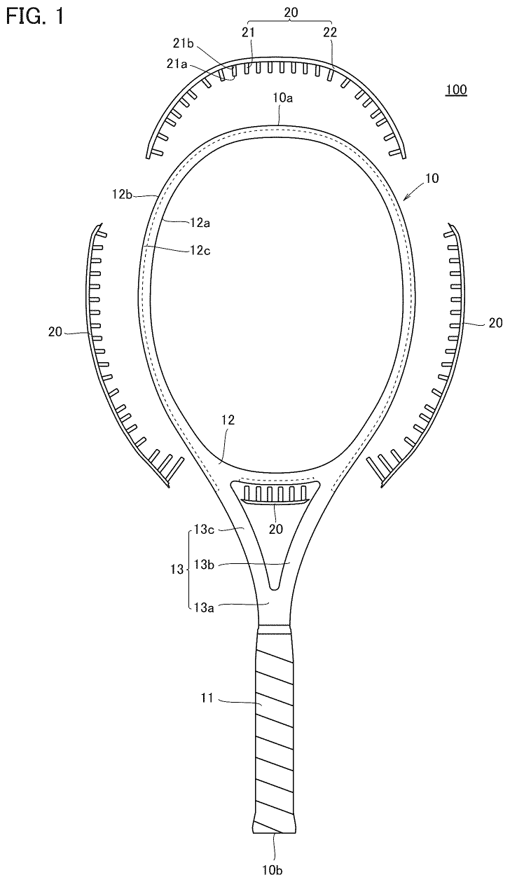

FIG. 1 is an exploded plan view of racket 100. As shown in FIG. 1, racket 100 includes a racket body 10 and a plurality of grommets 20. Racket body 10 has a tip end 10a and a base end 10b in its longitudinal direction. Base end 10b is located opposite to tip end 10a. Racket body 10 includes a grip 11, a frame 12, and a shaft 13. Racket body 10 is formed from fiber reinforced plastic (FRP), for example.

Grip 11 is a portion to be gripped by a user of racket 100. Grip 11 extends along the longitudinal direction of racket body 10. Grip 11 is located toward base end 10b of racket body 10.

Frame 12 has an annular shape as seen in plan view. More specifically, frame 12 has an elliptical annular shape as seen in plan view. A direction of the major axis of this elliptical annular shape is along the longitudinal direction of racket body 10. Frame 12 does not need to have an exactly elliptical annular shape as seen in plan view. Frame 12 is disposed at a distance from grip 11 in the longitudinal direction of racket body 10. Frame 12 is located toward tip end 10a of racket body 10.

Frame 12 has an inner circumferential surface 12a and an outer circumferential surface 12b. Outer circumferential surface 12b is provided with a groove 12c. Groove 12c is continuously formed. Frame 12 is provided with a plurality of through holes 12d (not shown). Through holes 12d each pass through frame 12 to open at inner circumferential surface 12a and a bottom surface of groove 12c. Through holes 12d each extend along either the longitudinal direction of racket body 10 or a width direction of racket body 10.

Shaft 13 has a first portion 13a, a second portion 13b, and a third portion 13c. First portion 13a extends along the longitudinal direction of racket body 10. First portion 13a has one end coupled to grip 11. First portion 13a has the other end coupled to one end of second portion 13b and one end of third portion 13c.

Second portion 13b and third portion 13c each have the other end coupled to a portion of outer circumferential surface 12b that is located toward base end 10b. Grip 11 and frame 12 are thus coupled to each other. The other end of third portion 13c is located opposite to the other end of second portion 13b with respect to the center in the width direction of racket body 10, as seen in plan view. In other words, shaft 13 is bifurcated between first portion 13a and frame 12.

A portion of frame 12 that is located toward tip end 10a is referred to as a top portion. A portion of frame 12 that is located between the other end of second portion 13b and the other end of third portion 13c is referred to as a yoke portion. A portion of frame 12 that is located between the other end of second portion 13b and the top portion is referred to as a first side portion. A portion of frame 12 that is located between the other end of third portion 13c and the top portion is referred to as a second side portion. Each of the plurality of grommets 20 is attached to a corresponding one of the top portion, the yoke portion, the first side portion and the second side portion of frame 12. Grommet 20 is disposed in groove 12c. Grommet 20 is formed from a resin material, for example.

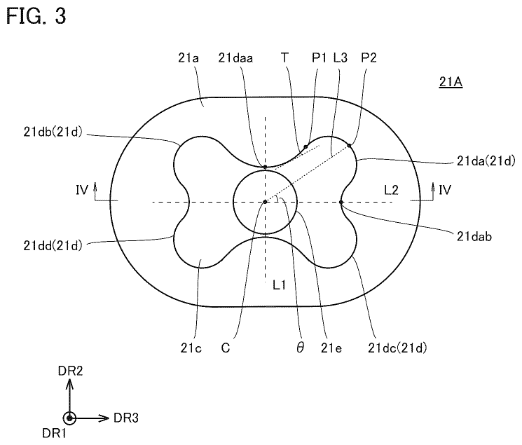

Grommet 20 includes a plurality of tubular portions 21 and a coupling portion 22. A direction in which each tubular portion 21 extends is referred to as a first direction DR1 (see FIGS. 3, 4, 5 and 6). Tubular portion 21 has a tip end 21a and a base end 21b in first direction DR1. Base end 21b is located opposite to tip end 21a. Tubular portion 21 is provided with a through hole 21c passing therethrough along first direction DR1 (see FIGS. 3, 4, 5 and 6). Through hole 21c opens at tip end 21a and base end 21b. The plurality of tubular portions 21 are coupled together by coupling portion 22 at base end 21b. Tubular portion 21 is inserted in through hole 12d from the outer circumferential surface 12b side (the bottom surface side of groove 12c). Grommet 20 is thus attached to frame 12.

A surface of coupling portion 22 opposite to the surface coupled to tubular portion 21 is provided with a groove 22a (see FIGS. 3, 4, 5 and 6). Groove 22a is continuously formed along a direction in which coupling portion 22 extends. Through hole 21c is connected to groove 22a.

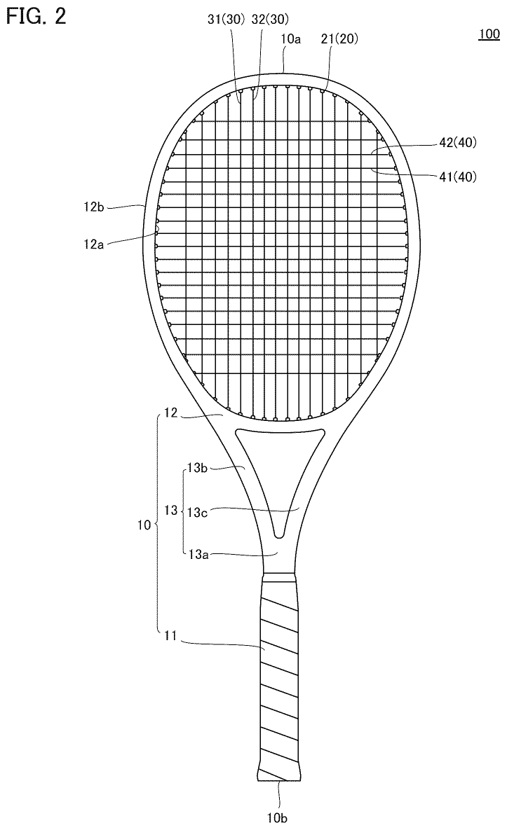

FIG. 2 is a plan view of racket 100. As shown in FIG. 2, racket 100 further includes main strings 30 and cross strings 40. Main strings 30 are each strung through through hole 21c in tubular portion 21 that is inserted in through hole 12d extending along the longitudinal direction of racket body 10. Cross strings 40 are each strung through through hole 21c in tubular portion 21 that is inserted in through hole 12d extending along the width direction of racket body 10.

Two of main strings 30 adjacent to each other in the width direction of racket body 10 are referred to as a first portion 31 and a second portion 32, respectively. Two of cross strings 40 adjacent to each other in the longitudinal direction of racket body 10 are referred to as a first portion 41 and a second portion 42, respectively. A portion of main strings 30 that is located between first portion 31 and second portion 32, and a portion of cross strings 40 that is located between first portion 41 and second portion 42 are disposed in groove 22a.

### <Specific Configuration of Grommet 20>

A specific configuration of grommet 20 is described below.

Tubular portion 21 inserted in through hole 12d extending along the longitudinal direction of racket body 10 is referred to as a tubular portion 21A. Tubular portion 21 inserted in through hole 12d extending along the width direction of racket body 10 is referred to as a tubular portion 21B.

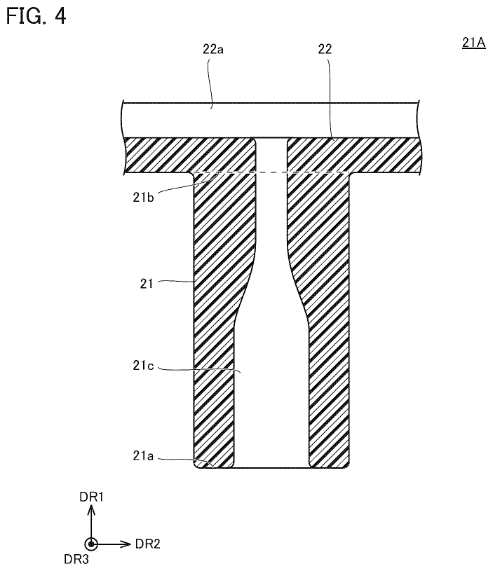

FIG. 3 is an end view of tubular portion 21A. FIG. 4 is a cross-sectional view along a line IV-IV in FIG. 3. As shown in FIGS. 3 and 4, tubular portion 21A has an elliptical outer circumferential shape, for example, when viewed from tip end 21a along first direction DR1 (hereinafter referred to as “in end view”). First direction DR1 in tubular portion 21A is along the longitudinal direction of racket body 10.

Tubular portion 21A has a smaller width in a second direction DR2 than its width in a third direction DR3. Second direction DR2 is orthogonal to first direction DR1. Second direction DR2 is along a normal direction of a hitting surface of racket 100. Third direction DR3 is orthogonal to first direction DR1 and second direction DR2. Third direction DR3 in tubular portion 21A is along the width direction of racket body 10. A longitudinal direction of tubular portion 21A as seen in end view is along third direction DR3. The outer circumferential shape of tubular portion 21 as seen in end view is not limited as such. Tubular portion 21A may have a circular outer circumferential shape, for example, as seen in end view.

An opening edge of through hole 21c at tip end 21a is referred to as an opening edge 21d. Opening edge 21d has a first portion 21da, a second portion 21db, a third portion 21dc, and a fourth portion 21dd, as seen in end view. The center of through hole 21c as seen in end view is referred to as a center C. A line passing through center C and parallel to second direction DR2 as seen in end view is referred to as a line L1. A line passing through center C and parallel to third direction DR3 as seen in end view is referred to as a line L2.

First portion 21da has a first end 21daa and a second end 21dab. First end 21daa is an intersection point of line L1 and opening edge 21d. Second end 21dab is an intersection point of line L2 and opening edge 21d. There are a position P1 and a position P2 on first portion 21da. Position P2 is further away from first end 21daa than position P1 on first portion 21da.

A tangent of first portion 21da is referred to as a tangent T. A slope of tangent T (angle formed between tangent T and line L2) is zero, for example, at first end 21daa. From a different viewpoint, tangent T is parallel to third direction DR3 at first end 21daa. The slope of tangent T increases from first end 21daa toward position P1 on first portion 21da. The slope of tangent T decreases from position P1 toward position P2 on first portion 21da. From a different viewpoint, position P1 is an inflection point of a curve indicated by first portion 21da.

A distance between first portion 21da and center C as seen in end view is referred to as a distance DIS. Distance DIS is at its maximum at position P2. Distance DIS preferably decreases from position P2 toward second end 21dab on first portion 21da.

A line passing through center C and position P2 as seen in end view is referred to as a line L3. An angle formed between line L3 and line L2 is referred to as an angle θ. Angle θ is preferably greater than 0° and smaller than or equal to 62°. Angle θ is more preferably greater than or equal to 7° and smaller than or equal to 56°. Angle θ is still more preferably greater than or equal to 150 and smaller than or equal to 480.

Second portion 21db is preferably line-symmetric with first portion 21da with respect to line L1 as seen in end view. Third portion 21dc is preferably line-symmetric with first portion 21da with respect to line L2 as seen in end view. Fourth portion 21dd is preferably point-symmetric with first portion 21da with respect to center C as seen in end view. In other words, opening edge 21d is preferably X-shaped as seen in end view. An opening edge of through hole 21c at base end 21b is referred to as an opening edge 21e. A maximum value of an opening diameter of opening edge 21e is preferably smaller than or equal to a minimum value of an opening diameter of opening edge 21d. Opening edge 21e has a circular shape, for example.

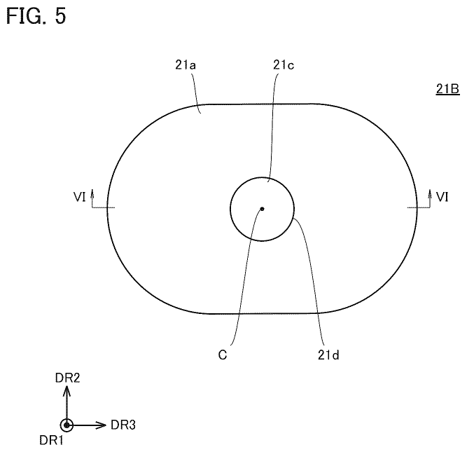

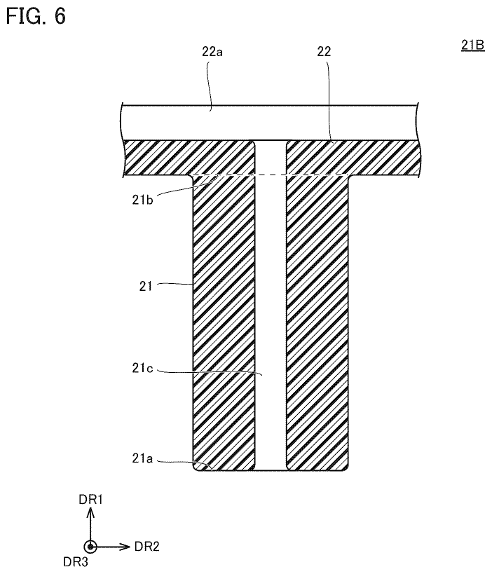

Tubular portion 21B is different from tubular portion 21A in the configuration of through hole 21c, and is otherwise common in configuration to tubular portion 21A. Note that first direction DR1 in tubular portion 21B and third direction DR3 in tubular portion 21B are along the width direction of racket body 10 and the longitudinal direction of racket body 10, respectively. FIG. 5 is an end view of tubular portion 21B. FIG. 6 is a cross-sectional view along a line VI-VI in FIG. 5. As shown in FIGS. 5 and 6, in tubular portion 21B, opening edge 21d has a circular shape, for example, as seen in end view. In tubular portion 21B, through hole 21c has a constant inner diameter, for example, from tip end 21a toward base end 21b.

### <Effects of Racket 100>

Effects of racket 100 will now be described, as contrasted with a comparative example. A racket according to the comparative example is referred to as a racket 200. Racket 200 is common in configuration to racket 100, except that opening edge 21d of tubular portion 21A has an elliptical shape in which the major axis is oriented along third direction DR3 as seen in end view.

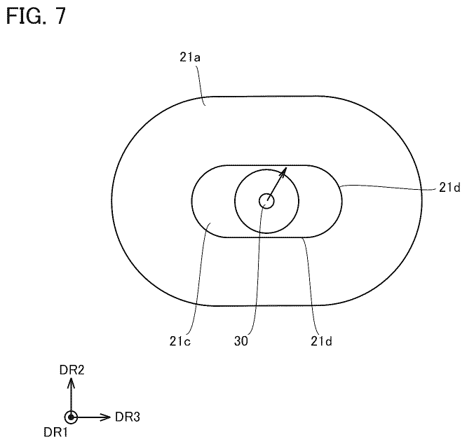

FIG. 7 is a schematic diagram illustrating movement of main string 30 in racket 200. The movement of main string 30 is represented by an arrow in FIG. 7. As shown in FIG. 7, when hitting a spin shot by racket 100, a direction in which main string 30 is going to move forms an angle of approximately 600 with respect to third direction DR3. Therefore, main string 30 initially comes into contact with opening edge 21d of tubular portion 21A and its movement in third direction DR3 is reduced, which hinders the application of a spin to the ball.

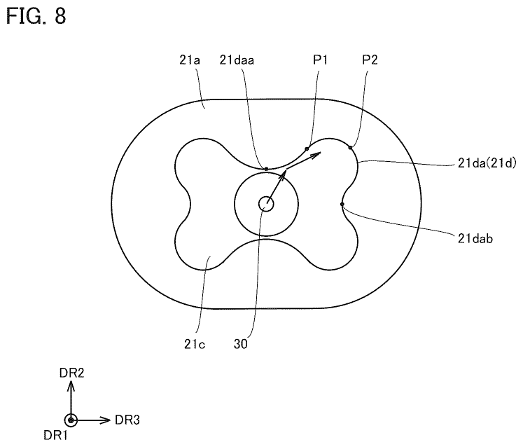

FIG. 8 is a schematic diagram illustrating movement of main string 30 in racket 100. The movement of main string 30 is represented by arrows in FIG. 8. As shown in FIG. 8, when hitting a spin shot by racket 100 as well, the direction in which main string 30 is going to move forms an angle of approximately 60° with respect to third direction DR3. In tubular portion 21A of racket 100, the slope of tangent T increases between first end 21daa and position P1. Thus, main string 30 and opening edge 21d of tubular portion 21A are less likely to initially come into contact with each other. Further, in tubular portion 21A of racket 100, the slope of tangent T decreases between position P1 and position P2. Thus, main string 30 is guided to move along third direction DR3. According to racket 100, therefore, the movement of main string 30 in third direction DR3 is increased, which facilitates the application of a spin to the ball.

Opening edge 21d of tubular portion 21A has first portion 21da, second portion 21db, third portion 21dc, and fourth portion 21dd. Second portion 21db is line-symmetric with first portion 21da with respect to line L1, third portion 21dc is line-symmetric with first portion 21da with respect to line L2, and fourth portion 21dd is point-symmetric with first portion 21da with respect to center C. According to racket 100, therefore, the application of a spin to the ball is similarly facilitated not only when a right-handed user hits a forehand shot, but also when the right-handed user hits a backhand shot or a left-handed user hits a forehand or backhand shot.

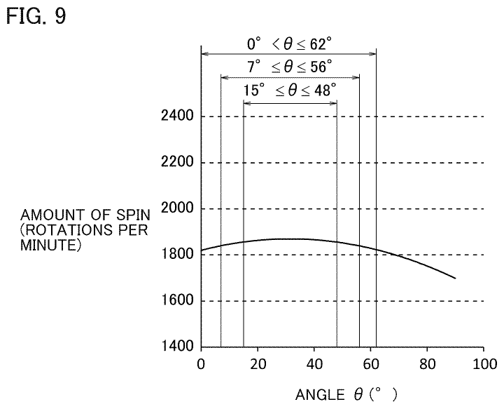

FIG. 9 is a graph showing results of a repulsion test using racket 100. The horizontal axis in FIG. 9 represents the amount of spin (unit: rotations per minute), and the horizontal axis in FIG. 9 represents angle θ (unit: °). In the repulsion test, grip 11 was secured to a jig. In the repulsion test, tennis balls were launched toward the hitting surface of racket 100 so as to form an angle of 20° with the hitting surface of racket 100. In the repulsion test, the amount of spin of each tennis ball that impacted and bounced off the hitting surface of racket 100 was measured with a high-speed camera.

As shown in FIG. 9, the amount of spin of the tennis ball that impacted and bounced off the hitting surface of racket 100 increased as angle θ was increased, and the amount of spin of the tennis ball that impacted and bounced off the hitting surface of racket 100 had a maximum value when angle θ was close to 25°. When angle θ was greater than 0° and smaller than or equal to 62°, the amount of spin of the tennis ball that impacted and bounced off the hitting surface of racket 100 was higher than when angle θ was 0°. When angle θ was greater than or equal to 7° and smaller than or equal to 56°, the amount of spin of the tennis ball that impacted and bounced off the hitting surface of racket 100 increased by one percent or more, as compared to when angle θ was 0°. When angle θ was greater than or equal to 15° and smaller than or equal to 48°, the amount of spin of the tennis ball that impacted and bounced off the hitting surface of racket 100 increased by two percent or more, as compared to when angle θ was 0°. Based on these results, it was found that the application of a spin to the ball is facilitated when angle θ is greater than 0° and smaller than or equal to 62°, and the application of a spin to the ball is further facilitated when angle θ is greater than or equal to 7° and smaller than or equal to 560 (preferably greater than or equal to 150 and smaller than or equal to 48°).

In tubular portion 21A of racket 100, since distance DIS decreases from position P2 toward second end 21dab on first portion 21da, tubular portion 21A has an increased thickness near second end 21dab, and thus has improved durability. Further, in tubular portion 21A of racket 100, since the maximum value of the opening diameter of opening edge 21e is smaller than or equal to the minimum value of the opening diameter of opening edge 21d, main string 30 readily moves back to its original position after moving along third direction DR3.

### Modification

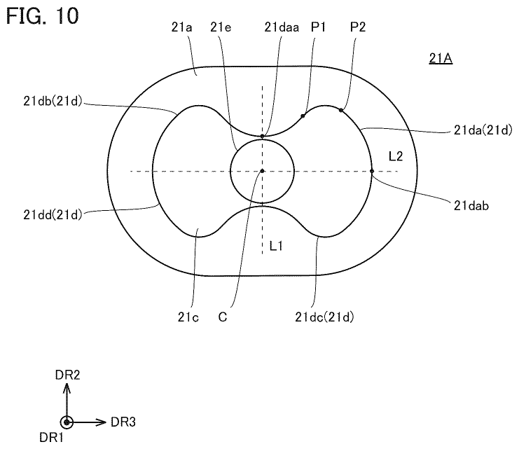

FIG. 10 is an end view of tubular portion 21A in racket 100 according to a modification. As shown in FIG. 10, in tubular portion 21A, distance DIS does not need to decrease from position P2 toward second end 21dab on first portion 21da. Further, in tubular portion 21A, distance DIS does not need to have the maximum value at position P2. In this case as well, the movement of main string 30 in third direction DR3 is increased, which facilitates the application of a spin to the ball.

### Second Embodiment

A racket according to a second embodiment is described. The racket according to the second embodiment is referred to as a racket 100A. Here, differences from racket 100 will be mainly described and the same description will not be repeated.

Racket 100A includes racket body 10, grommets 20, main strings 30, and cross strings 40. In racket 100A, grommet 20 includes tubular portions 21 (tubular portion 21A and tubular portion 21B) and coupling portion 22. In racket 100A, tubular portion 21 is provided with through hole 21c. In racket 100A, opening edge 21d of tubular portion 21A is X-shaped as seen in end view. Racket 100A is common in configuration to racket 100 in these respects.

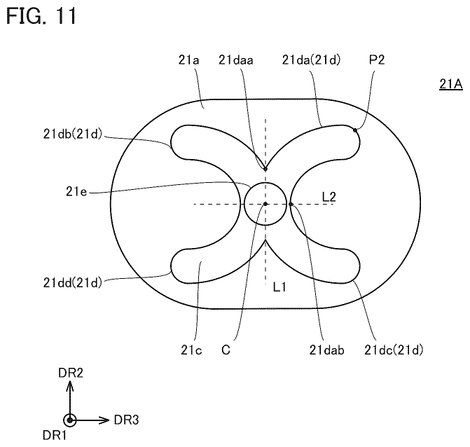

However, racket 100A is different in configuration from racket 100 in the shape of through hole 21c in tubular portion 21A. FIG. 11 is an end view of tubular portion 21A in racket 100A. As shown in FIG. 11, in tubular portion 21A of racket 100A, the slope of the tangent of the curve indicating first portion 21da at first end 21daa has a positive value.

Further, in tubular portion 21A of racket 100A, there is no inflection point of the curve indicating first portion 21da between first end 21daa and position P2 (position on first portion 21da with the maximum distance from center C), and the slope of the tangent of the curve indicating first portion 21da decreases from first end 21daa toward position P2. Racket 100A is different in configuration from racket 100 in these respects.

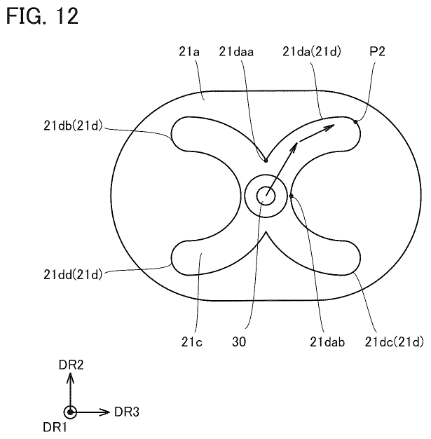

FIG. 12 is a schematic diagram illustrating movement of main string 30 in racket 100A. The movement of main string 30 is represented by arrows in FIG. 12. As shown in FIG. 12, when hitting a spin shot by racket 100A as well, main string 30 is guided to move along third direction DR3 by the shape of opening edge 21d.

According to racket 100A, therefore, the movement of main string 30 in third direction DR3 is increased, which facilitates the application of a spin to the ball.

### Modification

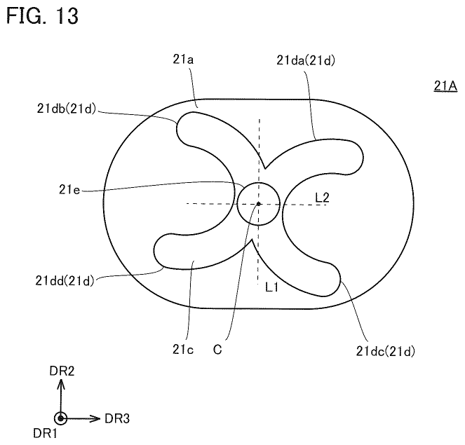

FIG. 13 is an end view of tubular portion 21A in racket 100A according to a modification. As shown in FIG. 13, the X shape of through hole 21c may be rotated about center C as seen in end view. In this case as well, the movement of main string 30 in third direction DR3 is increased, which facilitates the application of a spin to the ball.

Although the embodiments of the present invention have been described, the embodiments described above can be modified in various ways. Further, the scope of the present invention is not limited to the embodiments described above. The scope of the present invention is defined by the terms of the claims, and is intended to include any modifications within the scope and meaning equivalent to the terms of the claims.

### REFERENCE SIGNS LIST

100 racket; 10 racket body; 10a tip end; 10b base end; 11 grip; 12 frame; 12a inner circumferential surface; 12b outer circumferential surface; 12c groove; 12d through hole; 13 shaft; 13a first portion; 13b second portion; 13c third portion; 20 grommet; 21, 21A, 21B tubular portion; 21a tip end; 21b base end; 21c through hole; 21d opening edge; 21e opening edge; 21da first portion; 21daa first end; 21dab second end; 21db second portion; 21dc third portion; 21dd fourth portion; 22 coupling portion; 22a groove; 30 main string; 31 first portion; 32 second portion; 40 cross string; 41 first portion; 42 second portion; 100A, 200 racket; C center; DIS distance; DR1 first direction; DR2 second direction; DR3 third direction; L1, L2, L3 line; P1, P2 position; T tangent.

1. A grommet comprising a tubular portion, wherein
the tubular portion extends along a first direction, and has a tip end and a base end located opposite to the tip end in the first direction,
the tubular portion is provided with a through hole extending in the first direction and opening at the tip end and the base end, and
when the tubular portion is viewed from the tip end along the first direction,
a first opening edge has a first portion, the first opening edge being an opening edge of the through hole at the tip end,
the first portion has a first end and a second end, the first end being an intersection point of a first line and the first opening edge, the first line passing through a center of the through hole and along a second direction orthogonal to the first direction, the second end being an intersection point of a second line and the first opening edge, the second line passing through the center and along a third direction orthogonal to the first direction and the second direction,
there are a first position and a second position on the first portion, the second position being further away from the first end than the first position in the third direction, and
a slope of a tangent of the first portion increases from the first end toward the first position, and decreases from the first position toward the second position.

2. The grommet according to claim 1, wherein
a distance between the first portion and the center is at its maximum at the second position, and
when the tubular portion is viewed from the tip end along the first direction, an angle formed between a third line passing through the center and the second position and the second line is greater than 0° and smaller than or equal to 62°.

3. The grommet according to claim 2, wherein
when the tubular portion is viewed from the tip end along the first direction, the angle formed between the third line and the second line is greater than or equal to 7° and smaller than or equal to 56°.

4. The grommet according to claim 1, wherein
when the tubular portion is viewed from the tip end along the first direction, a distance between the first portion and the center decreases from the second position toward the second end.

5. The grommet according to claim 1, wherein
when the tubular portion is viewed from the tip end along the first direction,
the first opening edge further has a second portion, a third portion, and a fourth portion,
the second portion is line-symmetric with the first portion with respect to the first line,
the third portion is line-symmetric with the first portion with respect to the second line, and
the fourth portion is point-symmetric with the first portion with respect to the center.

6. The grommet according to claim 1, wherein
a maximum value of an opening diameter of a second opening edge is smaller than or equal to a minimum value of an opening diameter of the first opening edge, the second opening edge being an opening edge of the through hole at the base end.

7. A grommet comprising a tubular portion, wherein
the tubular portion extends along a first direction, and has a tip end and a base end located opposite to the tip end in the first direction,
the tubular portion is provided with a through hole extending in the first direction and opening at the tip end and the base end, and
when the tubular portion is viewed from the tip end along the first direction, a first opening edge is X-shaped, the first opening edge being an opening edge of the through hole at the tip end.
